(19) United States
(12) Patent Application Publication
(10) Pub. No.: US 2015/0030898 A1
(43) Pub. Date: Jan. 29, 2015

(54) METHOD AND DEVICE FOR IDENTIFYING AN INCREASE IN TEMPERATURE IN A PLURALITY OF ELECTROCHEMICAL STORAGE CELLS

(71) Applicant: Robert Bosch GmbH, Stuttgart (DE)

(72) Inventors: Stefan Butzmann, Schalksmuhle (DE); Jens Boehme, Gerlingen (DE)

(21) Appl. No.: 14/337,383

(22) Filed: Jul. 22, 2014

(30) Foreign Application Priority Data
Jul. 24, 2013 (DE) 10 2013 214 448.2

(51) Int. Cl. H01M 10/48; G01K 7/16; H01M 10/0525

(52) U.S. Cl. CPC H01M 10/486; H01M 10/0525; G01K 7/16; H01M 2220/20
USPC 429/90; 374/152

(57) ABSTRACT

A method and a device for identifying an increase in temperature in a plurality of electrochemical storage cells. An electrical characteristic value of a series connection of PTC elements that are thermally coupled in each case to a storage cell is determined and an increase in temperature of a plurality of electrical storage cells is identified if a value that is obtained as a result of evaluating the electrical characteristic value achieves a predefined threshold value.

### BACKGROUND OF THE INVENTION

The present invention relates to a method and also a device for identifying an increase in temperature in a plurality of electrochemical storage cells. In particular, the object of the present invention is to identify an additional protection against a battery cell phenomenon that is described as “thermal runaway”.

Batteries heat up as they supply energy and also as they absorb energy. The optimal operating temperature of a battery system of this type is approx. +5° C. to +35° C. Above an operating temperature of approx. +40° C., the service life of the battery decreases. It is therefore only possible to fulfill the service life requirement of approx. 8-10 years with the aid of an adequate process of thermally conditioning the battery with an active thermal management system in which the cells are kept in a thermally non-critical state of below +40° C. in all operating states. Furthermore, the temperature gradient from cell to cell can only amount to approx. 5 K for the purpose of synchronizing an aging process of the battery cells.

In order to avoid occasional dangerous damage to a vehicle, such as for example a vehicle fire, it is necessary by means of rapidly identifying an increase in temperature and activating safety devices to avoid in all circumstances a “thermal runaway” of the battery as a result of damage, in other words as result of a malfunction.

Temperature sensors are therefore important and indispensable system components for the purpose of measuring the cell temperatures and controlling the efficient thermal management system for the reliable operation that also limits the aging process of lithium ion and/or lithium polymer batteries.

### SUMMARY OF THE INVENTION

The object of the invention is therefore to provide a cost-effective and rapidly reacting temperature-sensing concept in particular for air-cooled lithium ion and/or lithium polymer battery systems.

The above mentioned requirement is achieved in accordance with the invention by virtue of a method for identifying an increase in temperature in a plurality of electrochemical storage cells. The plurality of electrochemical storage cells can be constructed by way of example from lithium ion and/or lithium polymer cells. Cells of this type are used by way of example as traction batteries, in other words for driving vehicles that can be driven in an electrical manner. Advantageously, it is not necessary for the electrochemical storage cells to be thermally coupled to one another for the purpose of applying the method in accordance with the invention. In other words, it is possible without the need for a separate evaluating unit to identify an increase in temperature of a single electrochemical storage cell in the connection. In accordance with the invention, the method comprises the step of determining an electrical characteristic value of an electrical series of PTC elements that are thermally coupled in each case to a storage cell. In other words, a measurement is initially performed on a current, a voltage or a resistance of a series connection of PTC elements. This measurement can be performed continuously during the running operation or it can be performed once or at predefined intervals (time- and/or event-driven). Subsequently, an increase in temperature of the plurality of electrochemical storage cells is identified if a value that is obtained as result of evaluating the electrical characteristic value of the PTC elements achieves a predefined threshold. In other words, the electrical characteristic value is evaluated and by way of example an electrical resistance, an electrical current or an electrical voltage (combinations of these characteristic values are also possible) is determined and is compared with a predefined threshold value. If the threshold value is achieved, a critical increase in temperature at least of one of the plurality of electrochemical storage cells is identified. The method in accordance with the invention renders it possible using a simple construction and unproblematic operation to improve safety while drawing energy from or supplying energy to an electrical energy storage device and also ensures a long service life of the electrical energy storage device.

The threshold value can also be selected as an absolute value (single value) and/or as a change of the electrical characteristic value per unit of time. In the case of using the option “characteristic value change per unit of time”, it is possible to establish different threshold values for different absolute characteristic value ranges. While a single characteristic renders it possible to determine a critical temperature value within the plurality of electrochemical storage cells in a particularly simple manner, an extensive (dynamic) monitoring of the processes within the electrochemical storage cells is possible by virtue of a change of the electrical characteristic value per unit of time.

It is also possible to determine the electrical characteristic value with regards to its change over the course of time. A direct measurement of a change in characteristic values offers the advantage that, in comparison with a threshold value in accordance with the option “change in characteristic values per unit of time”, it is not necessary to store values that are determined at an earlier time and a quicker evaluation and reaction to the change in temperature is possible.

It is preferred that the threshold value is predefined as a resistance value and is selected in such a manner that in the case of a common predefined temperature of all electrochemical storage cells (or rather of the PTC elements that are arranged on said storage cells), the determined resistance value is clearly lower than the predefined threshold value. By way of example, the threshold value can be one, two, three or four powers of ten higher than the electrical resistance of the series connection in the case of the predefined temperature. The predefined temperature can be established by way of example as the nominal temperature of the PTC elements. In other words, the behavior of the electrical resistance with respect to the temperature changes drastically above the nominal temperature, whereby the changed behavior of at least one cell of the plurality of electrochemical storage cells can be determined in a simple manner using measuring technology.

In accordance with a further aspect of the present invention, a device for identifying an increase in temperature in a plurality of electrochemical storage cells is proposed. The device comprises an electrical series connection of a plurality of PTC elements. The PTC elements can be adapted to suit the application in a specific type of electrochemical storage cells, in that the nominal temperature of the PTC elements is in a critical temperature range for the storage cells. Furthermore, the device comprises an evaluating unit for determining an electrical characteristic value of the electrical series connection of PTC elements. As performed in conjunction with the method in accordance with the invention, the electrical characteristic value can be for example a current, a voltage, a resistance value or a user-defined combination of the above mentioned values. The evaluating unit is designed so as to determine an electrical characteristic value of the electrical series connection of the PTC elements. This can be ensured by way of example by virtue of two electrical connectors (“test connections”) on the two sides of the series connection and said connectors are electrically connected to the evaluating unit. Furthermore, the evaluating unit is designed so as to identify an increase in temperature in the series connection if a value that is obtained as a result of evaluating the electrical characteristic value of the PTC elements achieves a predefined threshold value. In this manner, a simple construction is provided that requires only a small expenditure with regard to the cables and comprises only one evaluating unit for a plurality of electrochemical storage cells.

It is preferred that the PTC elements are designed so as to be thermally coupled in each case to an electrochemical storage cell of a second plurality of electrochemical storage cells. An arrangement of this type is to be described as a thermal coupling in which the temperature of the PTC elements is correlated with a temperature of a respective electrochemical storage cell in an expedient manner using measuring technology. For this purpose, the PTC elements can be placed in particular on the so called “cap-plates” (“terminal plates” or “terminal connectors”) of the electrochemical storage cell. An arrangement of this type offers considerable free space in the case of constructing the electrochemical storage devices.

It is preferred that the PTC elements comprise a nominal temperature in the range between 50 and 80° C., preferably between 60 and 70° C. Said temperature ranges have proven advantageous for the application in electrochemical storage cells in order to extend their service life.

It is further preferred that the evaluating unit is designed for the purpose of receiving measuring signals from other sensor arrangements and performing a plausibility test of the increase in temperature with reference to said measuring signals. In other words, further sensor arrangements could be connected to the evaluating unit or can already be connected to said evaluating unit by means of which it is possible to determine characteristic values for the purpose of determining the operating state of the electrochemical storage cells, in particular with regard to their temperature. This offers the advantage of ensuring the best possible operation of an electrochemical storage device.

In accordance with a further aspect of the present invention, an electrochemical storage device is proposed that comprises a plurality of electrochemical storage cells and a device such as that discussed in the second invention aspect mentioned above. The features, the functions and also the advantages are similar to the abovementioned embodiments.

### BRIEF DESCRIPTION OF THE DRAWINGS

Exemplary embodiments of the invention are described in detail hereinunder with reference to the accompanying drawings. In the drawings:

FIG. 1 illustrates a resistance-temperature diagram of a typical PTC element;

FIG. 2 illustrates a schematic plan view of an exemplary embodiment of an electrochemical storage device having a device in accordance with the present invention, and

FIG. 3 illustrates a flow diagram illustrating steps in accordance with an exemplary embodiment of the method in accordance with the invention.

### DETAILED DESCRIPTION

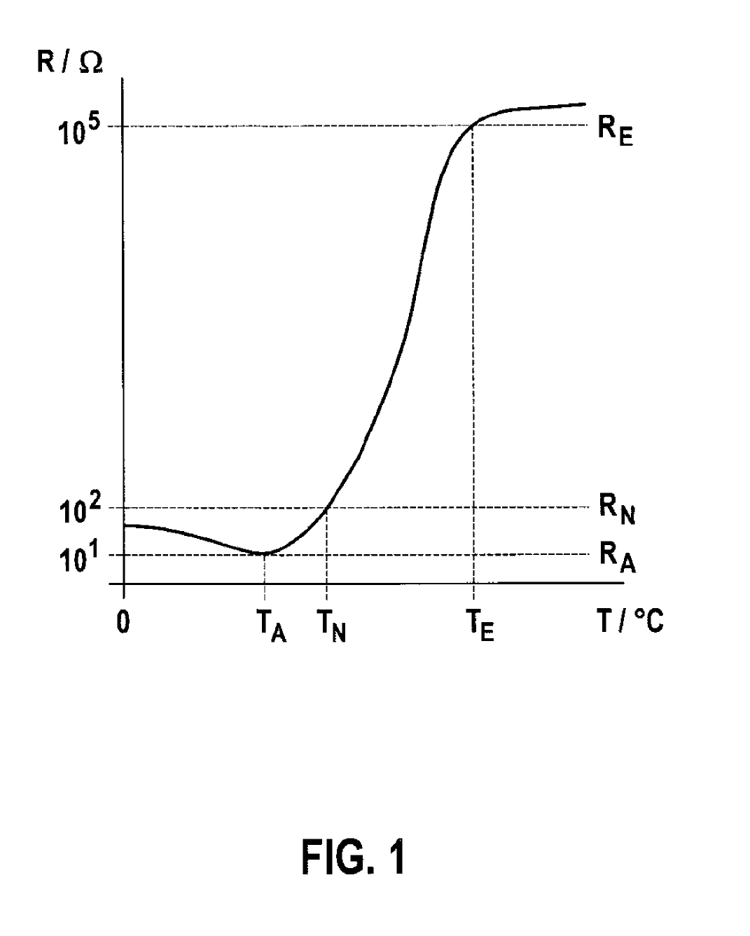

FIG. 1 illustrates the progression of a resistance of a PTC element, as can be found in the method in accordance with the invention, with respect to the temperature. In FIG. 1, the x-axis is illustrated as linear and the y-axis is illustrated in a logarithmic manner. Between a temperature of 0° C. up to an activating temperature TA, the resistance progresses essentially in a linear manner and decreases slightly. Between the activating temperature TA and a nominal temperature TN, the resistance increases with respect to the temperature in an essentially linear manner. After the temperature TN, the behavior of the resistance with respect to the temperature drastically changes. Between the nominal temperature TN and the end temperature TE, the resistance increases approximately exponentially.

Fundamentally, there are different types of thermistors, in other words temperature dependent resistors, for example NTC, PTC resistors, thermal elements, RTD (resistance temperature devices) etc. PTC resistors or cold conductors can be produced from different materials, thus inter alia also from a mix of (essentially) barium carbonate and titanium (IV)-oxide. PTCs of this type have in their working range between their nominal temperature TN and their end temperature TE an approximately exponential, strongly nonlinear temperature resistance characteristic curve corresponding to FIG. 1. The activating point of the nonlinear characteristic curve is the nominal temperature TN. Said nominal temperature corresponds to the ferroelectric Curie-temperature of the cold conductor. Above said Curie temperature a prompt switch is performed, a type of threshold value behavior, between low and high ohmic resistance values. In other words, cold conductors of this type are suitable for identifying and controlling an excess temperature during operation with a current in which no self-heating occurs. The temperature dependence of their resistance in the working range is described by means of the formula hereinunder:

R(T)=R_{N}·e^{b(T-TN)}

The individual symbols stand for the following values:

R(T)=Resistance in Ω in the case of the temperature T

e=natural exponential function (Euler Number=2.71828 . . . )

T=Operating temperature

T_{N}=Nominal Temperature

T_{E}=End Temperature

R_{A}=Minimal resistance in Ω in the case of the temperature TA, in the example 10Ω

R_{N}=Nominal resistance in Ω in the case of a nominal temperature TN, in the example 100Ω

R_{E}32 Resistance in Ω in the case of the temperature TE in the example 100Ω

b=positive temperature coefficient in 1/K

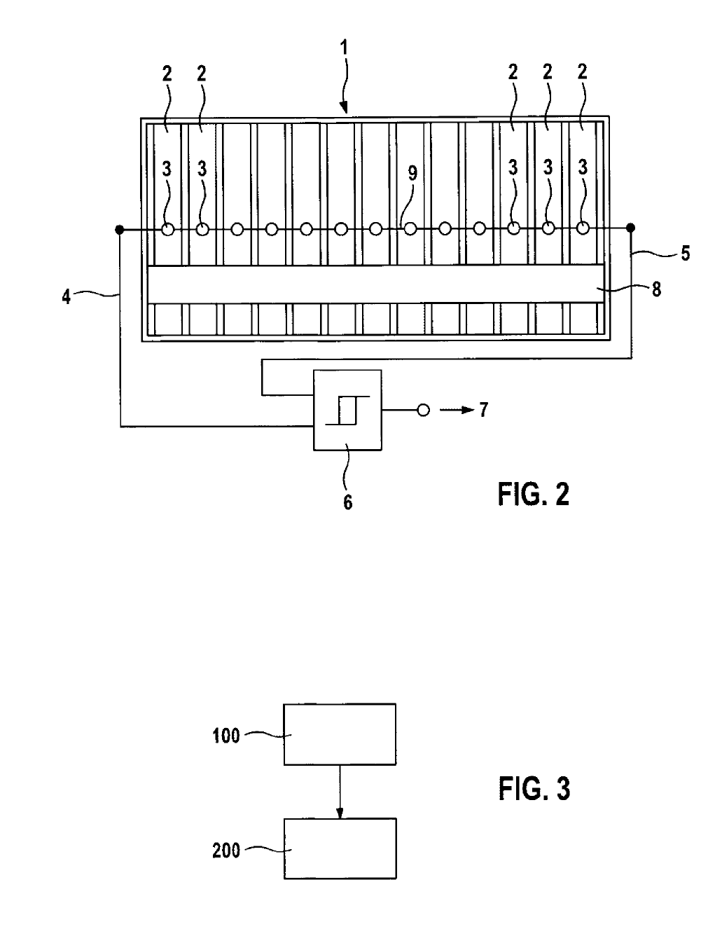

FIG. 2 illustrates a schematic plan view of an arrangement in accordance with the invention, comprising an electrochemical storage device 1 and a device in accordance with the invention. The electrochemical storage device 1 comprises a plurality (13 in the example) of electrochemical storage cells 2 that are combined by means of an assembly bridge 8. The electrochemical storage cells 2 are connected to one another by means of a series connection of 13 PTC elements 3 that in turn are connected together by way of an electrical conductor 9. Electrical connectors 4, 5 of an evaluating unit 6 are connected on the two sides of the series connection of the PTC elements 3. The evaluating unit 6 is designed for the purpose of outputting a logical “1” at a subsequent control unit 7, as soon as an electrical characteristic value of the series connection exceeds a predefined threshold value. For the purpose of ensuring a proper function, a hysteresis function is provided for the output of the logical “1”, in order to further provide consolidated measured values.

Owing to the great change in resistance of the described PTC elements 3 in the working range, a series connection of several PTC elements 3 suffices for the purpose of controlling the temperature of lithium ion and/or lithium polymer battery modules having for example up to 13 cells by means of a single evaluating unit 6. The nominal temperature TN of the PTC element 3 that is to be selected should be approximately 50° C. up to 80° C., preferably 60° C. to 70°. The individual PTC elements 3 of the series connection are placed on the cap plates for the purpose of achieving as direct a measurement as possible. A connection having two connectors 4, 5 suffices and only a single evaluating unit 6, for example a comparator having hysteresis, is required for the PTC series connection.

If the temperature of any one of the 13 storage cells 2 greatly exceeds a certain value and/or the temperature gradient of one of the storage cells 2 exceeds a defined value, it is immediately identified and a control unit 7 can rapidly react to it.

FIG. 3 illustrates two steps of an exemplary embodiment of a method in accordance with the invention. Step 100 comprises the process of determining an electrical characteristic value of an electrical series connection of PTC elements 3 that are thermally coupled in each case to a storage cell 2. This can be performed by way of example by means of an evaluating unit 6 (cf. FIG. 2). Subsequently, step 200 comprises the process of identifying an increase in temperature of a plurality of electrical storage cells 2 if a value that is obtained as a result of evaluating the electrical characteristic value achieves a predefined threshold value.

The safety of the occupants of vehicles that are driven by lithium ion batteries and electric motors is significantly improved by virtue of the invention. The core and advantages of the invention are that each individual thermally decoupled cell is monitored by means of a single electrical arrangement with two connectors.

Even if the aspects in accordance with the invention and the advantageous embodiments with reference to the exemplary embodiments that are explained in conjunction with the attached drawing figures are described in detail, modifications and combinations of features of the exemplary embodiments that are illustrated are possible for the person skilled in the art without having to depart from the range of the present invention whose protective scope is defined by means of the attached claims.

What is claimed is:

1. A method for identifying an increase in temperature in a plurality of electrochemical storage cells (2) comprising the steps of
determining (100) an electrical characteristic value of an electrical series connection of PTC elements (3) that are thermally coupled in each case to a storage cell, and
identifying (200) an increase in temperature in one of the electrical storage cells (2) if a value that is obtained as a result of evaluating the electrical characteristic value achieves a predefined threshold value.

2. The method according to claim 1, wherein the threshold value is an absolute value of the electrical characteristic value or a change of the electrical characteristic value per unit of time.

3. The method according to claim 1, wherein the electrical characteristic value is a voltage or a current or a resistance value.

4. The method according to claim 3, wherein the threshold value is a voltage or a current or a resistance value or in each case a change in said values per unit of time.

5. The method according to claim 1, wherein the threshold value is a voltage or a current or a resistance value or in each case a change in said values per unit of time.

6. The method according to claim 1, wherein the threshold value is a resistance value and is selected in such a manner that in the case of a common predefined temperature (T_{N}) of all electrochemical storage cells (2), the determined resistance value is one power of ten lower than the threshold value.

7. The method according to claim 6, wherein the predefined temperature (T_{N}) essentially corresponds to the nominal temperature of the PTC elements (3).

8. The method according to claim 1, wherein the threshold value is a resistance value and is selected in such a manner that in the case of a common predefined temperature (T_{N}) of all electrochemical storage cells (2), the determined resistance value is two powers of ten lower than the threshold value.

9. The method according to claim 8, wherein the predefined temperature (T_{N}) essentially corresponds to the nominal temperature of the PTC elements (3).

10. The method according to claim 1, wherein the threshold value is a resistance value and is selected in such a manner that in the case of a common predefined temperature (T_{N}) of all electrochemical storage cells (2), the determined resistance value is three powers of ten lower than the threshold value.

11. The method according to claim 10, wherein the predefined temperature (T_{N}) essentially corresponds to the nominal temperature of the PTC elements (3).

12. A device for identifying an increase in temperature in a plurality of electrochemical storage cells (2), the device comprising:
an electrical series connection of a first plurality of PTC elements (2), and
an evaluating unit (6) for determining an electrical characteristic value of the electrical series connection of PTC elements (3),
wherein the evaluating unit (6)
determines an electrical characteristic value of the electrical series connection of the PTC elements (2), and
identifies an increase in temperature if a value that is obtained as a result of evaluating the electrical characteristic value of the PTC elements (3) achieves a predefined threshold value.

13. The device according to claim 12, wherein the PTC elements (3) are in each case thermally coupled to an electrochemical storage cell (2) of a second plurality of electrochemical storage cells (2).

14. The device according to claim 13, wherein the PTC elements (3) are placed on cap plates of the electrochemical storage cells (2).

15. The device according to claim 12, wherein the PTC elements (3) comprise a nominal temperature (T_{N}) in the range between 50 and 80 degrees Celsius.

16. The device according to claim 12, wherein the PTC elements (3) comprise a nominal temperature (T_{N}) in the range between 60 to 70 degrees Celsius.

17. The device according to claim 12, wherein the evaluating unit (6) also receives measuring signals from other sensor arrangements and performs a plausibility test of the increase in temperature with reference to said measuring signals.

18. An electrochemical storage device (1) comprising
a plurality of electrochemical storage cells (2), and
a device in accordance with claim 12.
